(19) United States
(12) Patent Application Publication
(10) Pub. No.: US 2011/0128462 A1
(43) Pub. Date: Jun. 2, 2011

(54) COVER PLATE

(75) Inventors: Po-An Lin, Taipei City (TW); Kuo-Nan Ling, Taipei City (TW); Jung-Chin Wu, Taipei City (TW)

(73) Assignee: COMPAL ELECTRONICS, INC., Taipei City (TW)

(21) Appl. No.: 12/683,401

(22) Filed: Jan. 6, 2010

(30) Foreign Application Priority Data
Nov. 30, 2009 (TW) 98140873

(51) Int. Cl. G02F 1/1333; B32B 23/02; B32B 15/00; B32B 7/04

(52) U.S. Cl. 349/58; 428/533; 428/537.1; 428/480; 428/113; 428/411.1; 428/457

(57) ABSTRACT

A cover plate includes two substrates and a composite structure disposed between the two substrates. The cover plate has low specific weight and high strength. The composite structure includes an adhesive layer and a fiber layer disposed in the adhesive layer, where the fiber layer is made of degradable fibers or a composite material having degradable fibers fixed by a forming material.

### CROSS-REFERENCE TO RELATED APPLICATION

This application claims the priority benefit of Taiwan application serial no. 98140873, filed on Nov. 30, 2009. The entirety of the above-mentioned patent application is hereby incorporated by reference herein and made a part of specification.

### BACKGROUND OF THE INVENTION

1. Field of the Invention

The invention relates to a cover plate, and more particularly, to a cover plate having a composite structure.

2. Description of Related Art

In recent years, as portable electronic devices have more diverse functions and become more miniaturized, users are capable of receiving or inquiring important information during transportation or traveling with the convenience of wireless communication and wireless interne. Among them, functions and online services provided by handheld game consoles, cellular phones, and notebook computers gradually increase and become popularized.

In order to enhance portability, the thickness and weight of a notebook computer have been reduced continuously; also, the standby period of the battery and structural strength thereof have been increased. However, the reduction in thickness and weight and the increase in structural strength of the notebook computer are against one another in some designs. In particular, the advancement in light emitting diodes (LEDs) leads to a lighter and thinner backlight module in the notebook computer. Also, the thickness of liquid crystal display (LCD) module will definitely be thinner in the future. Consequently, the strength to be endured by the LCD module is challenged. Moreover, the notebook computer is the work platform that people carry around for storing large amount of data and application programs. If the structural strength does not satisfy the safety protection standard and is not pressure tolerant and collision tolerant, the portability of the notebook computer will then be troublesome. Therefore, enhancing the structural strength of the notebook computer and reducing the thickness and weight of the cover plate have always been the tasks to be solved by manufacturers.

In the design of enhancing strength, the structural design of the upper cover plate covering the LCD module is usually modified to enhance strength. For example, the configuration of the cover plate is modified into the shape of an arc, so as to distribute external pressure. However, the arc shape increases the size of the cover plate of the notebook computer. Thus, it is difficult to balance among the thickness, weight, and structural strength of the notebook computer. Hence, modifying the design of the cover plate of portable electronic devices for portable electronic devices to have satisfying performance in thickness, weight, and endurable strength is not only the optical goal of the designer, but also the desire of numerous consumers.

### SUMMARY OF THE INVENTION

The invention relates to a cover plate including a composite structure for reducing the weight of the cover plate, so that the cover plate has low specific weight and high strength.

The invention relates to a cover plate including two substrates and a composite structure. The composite structure is disposed between the two substrates and includes an adhesive layer and a fiber layer. The fiber layer is disposed in the adhesive layer and made of a degradable fiber or a composite material having the degradable fiber fixed by a forming material.

According to an embodiment of the invention, the degradable fiber includes a biodegradable fiber, a chemical degradable fiber, or a photodegradable fiber.

According to one embodiment of the invention, the biodegradable fiber comprises a plant fiber.

According to an embodiment of the invention, the plant fiber includes a bamboo fiber, a cane fiber, a flax fiber, a coconut fiber, or a mixture thereof.

According to an embodiment of the invention, the plant fiber includes a straw fiber, a corn husk fiber, or a mixture thereof.

According to an embodiment of the invention, the forming material includes a Mylar film or an artificial glass fiber sheet.

According to an embodiment of the invention, the fiber layer is an unevenly aligned mesh structure or a non-mesh structure.

According to an embodiment of the invention, the two substrates serve as an outer plate and an inner plate, and the outer plate covers the inner plate.

According to an embodiment of the invention, the outer plate includes an accommodating slot and the inner plate is disposed on an inner wall of the accommodating slot.

According to an embodiment of the invention, a liquid crystal display (LCD) module is placed inside the accommodating slot, and the LCD module and the inner plate are connected to each other.

According to an embodiment of the invention, a material of the outer plate includes tinplate, aluminum alloy, magnesium alloy, stainless steel, or titanium alloy.

According to an embodiment of the invention, a material of the inner plate includes tinplate, aluminum alloy, magnesium alloy, stainless steel, or titanium alloy.

According to an embodiment of the invention, the adhesive layer includes a first adhesive material and a second adhesive material, and the fiber layer is sandwiched between the first adhesive material and the second adhesive material.

In one embodiment of the invention, the first adhesive material and the second adhesive material are fabricated using the same material or different materials.

In one embodiment of the invention, a material of the first adhesive material includes acrylic gel, polyurethane (PU), epoxy resin, or silicone. In one embodiment of the invention, a material of the second adhesive material includes acrylic gel, PU, epoxy resin, or silicone.

In light of the foregoing, the cover plate of the invention has low specific weight and high strength. Moreover, compared with a metal cover plate having the same thickness, the weight of the cover plate of the invention is reduced. As a consequence, the requirements in product design can then be achieved.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a cover plate according to an embodiment of the invention.

FIG. 2 is a schematic view of a cover plate according to another embodiment of the invention.

FIGS. 3A-3C illustrate a flowchart of manufacturing a cover plate of the invention.

FIG. 4 is a schematic view of applying a cover plate of the invention in a liquid crystal display (LCD) module.

### DESCRIPTION OF EMBODIMENTS

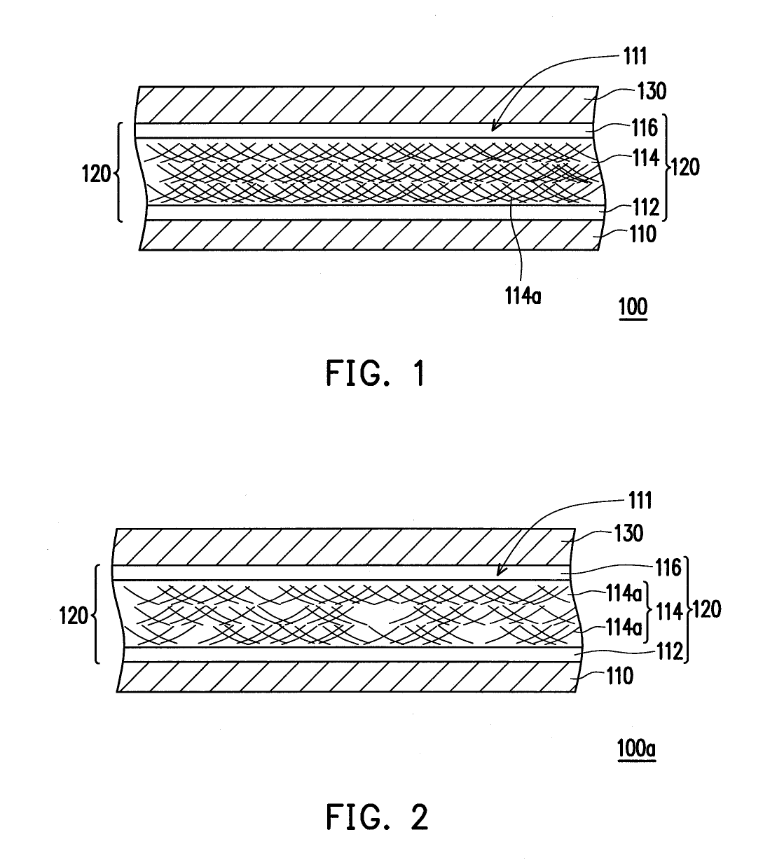

FIG. 1 is a schematic view of a cover plate according to an embodiment of the invention.

Referring to FIG. 1, in order to enhance the structural strength of a portable electronic device and reduce the weight of a cover plate, a cover plate 100 including a composite structure 120 is provided in the invention. The composite structure 120 includes an adhesive layer 111 and a fiber layer 114. The fiber layer 114 is located in the adhesive layer 111 and is adhered to two substrates 110, 130 on the outside to form an integrative unit through the adhesive layer 111. The fiber layer 114 is soaked into an adhesive material; or, the two surfaces of the fiber layer 114 can be adhered with a first adhesive material 112 and a second adhesive material 116, such that the fiber layer 114 is sandwiched between the two adhesive materials 112, 116. Compared to the strength of the combination of the fiber layer and the substrates, the strength of each of the fiber layer and the substrates individually is weaker. The fiber layer 114 is made of a degradable fiber, such as a biodegradable fiber, a chemical degradable fiber, or a photodegradable fiber, and so on. In the present embodiment, a biodegradable fiber is used as an example for illustration. The biodegradable fiber, for example, is a primitive plant fiber 114a or a processed plant fiber 114a. Moreover, water in the tissue body of the plant fiber 114a can be removed by solarization or baking. The plant fiber 114a is then suitably trimmed or pressurized to form a sheet-like substrate. However, the tissue body obtains the complete plant fiber 114a without damaging the original alignment direction and structure of the fiber. As a consequence, the fiber layer 114 retains the tenacity and features such as not-easily deformed and porous, thereby achieving the demand of high strength and lightweight to reduce the weight of the cover plate 100.

In the present embodiment, the fibers in the fiber layer 114 are aligned in interlace. That is, the fiber layer 114 is an unevenly aligned mesh structure or even a non-mesh structure. The plant fiber 114a adopted includes ligneous fibers, such as bamboo fibers, cane fibers, flax fibers, coconut fibers, or a mixture thereof. The plant fibers are longer and have rough textures and superior structural strength. Therefore, the plant fibers can be directly molded into cover plates with plate-shapes, arc-shapes, or various shapes according to the configuration of the product without adding any forming material. Take bamboo fibers as an example, after being trimmed or pressurized into a large bamboo sheet having uniform thickness, the bamboo fibers are then manufactured into the fiber layer 114 required by the cover plate 100. Other than the ligneous fibers listed above, other grass fibers or paper fibers having the same characteristics can also be utilized, and the invention is not limited thereto. Furthermore, plant fibers such as straw fibers, corn husk fibers, or a mixture thereof have shorter fibers and finer texture, such that the required fiber layer can be molded by doping adhesives or doping forming materials.

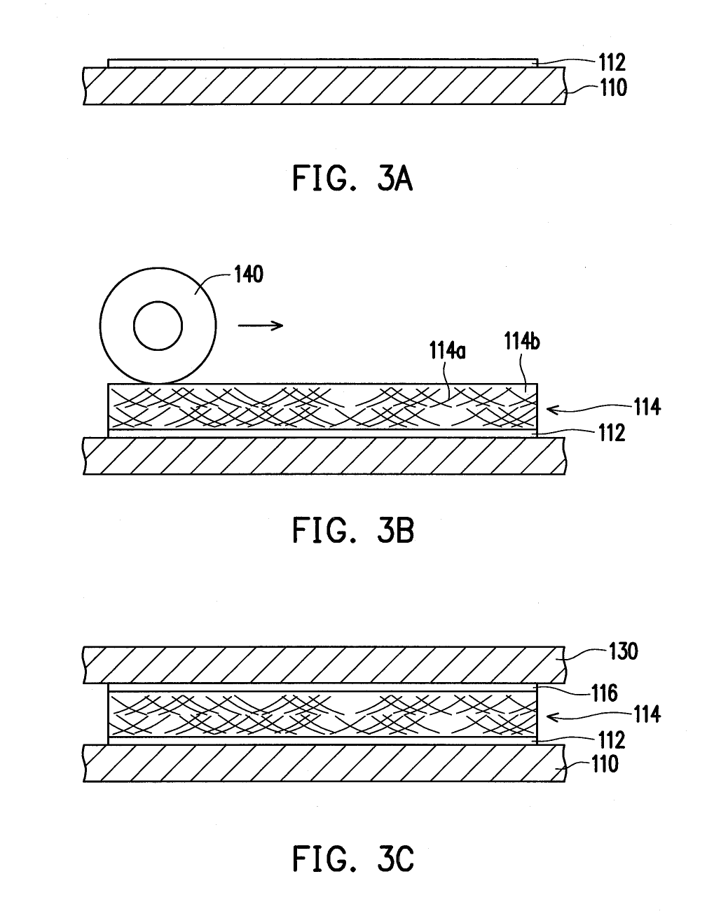

FIG. 2 is a schematic view of a cover plate according to another embodiment of the invention. FIGS. 3A-3C illustrate a flowchart of manufacturing a cover plate of the invention. A cover plate 100a includes a composite structure 120 having an adhesive layer 111 and a fiber layer 114. The fiber layer 114 is located in the adhesive layer 111 and is adhered to two substrates 110, 130 on the outside to form an integrative unit through the adhesive layer 111. The fiber layer 114 is soaked into an adhesive material; or, the two surfaces of the fiber layer 114 can be adhered with the first adhesive material 112 and the second adhesive material 116, such that the fiber layer 114 is sandwiched between the two adhesive materials 112, 116. A difference between the two embodiments is that the fiber layer 114 is made of a composite material having the degradable fiber (i.e. a plant fiber) 114a fixed by a forming material 114b. The forming material 114b, for example, is a Mylar film, an artificial glass fiber sheet, or materials of the same nature. The plant fiber 114a is distributed in the forming material 114b so as to reduce the weight and enhance the structural strength. The plant fiber 114a, for example, includes fibers such as bamboo fibers, cane fibers, flax fibers, coconut fibers and so on, or fibers such as straw fibers, corn husk fibers and so on. It should be noted that the invention is not limited thereto. The plant fiber 114a can be uniformly distributed or can reinforce more pressurized portions or more fragile portions of the cover plate structure.

Referring to FIGS. 3A-3C, a flowchart of manufacturing the cover plate aforementioned and the composite structure thereof is illustrated in the following. Firstly, a first adhesive material 112 is coated on a substrate 110. The first adhesive material 112 is flattened by using a spatula, so that the adhesive layer 112 has a uniform thickness. In the present embodiment, the substrate 110 is a metal thin plate made of stainless steel, tinplate, aluminum alloy, magnesium alloy, or titanium alloy, for example. Next, a fiber layer 114 is disposed on the first adhesive material 112. The fiber layer 114 and the first adhesive material 112 are pressed to be tightly bonded. For example, the fiber layer 114 can be pressed by using a roller 140 and then heated in the pressing process, but the pressing method is not limited thereto. The fiber layer 114 is a plant fiber 114a, for example. But if the fiber layer 114 includes a forming material 114b, the fiber layer 114 is formed before being pressurized. The forming material 114b may be first disposed on a surface of the plant fiber 114a. The forming material 114b and the plant fiber 114a are then integrated through the pressurization of the roller 140. After the forming material 114b has been heated and cured, the fiber layer 114 is consequently formed. The first adhesive material 112 is made of acrylic gel, PU, epoxy resin, or silicone, which belongs to thermal curing resin, thus the first adhesive material 112 does not resume to the initial liquid state under normal temperature. A material of the first adhesive material 112 is not limited; however, the material has to adhere the fiber layer 114 and the substrates 110, 130 completely. Moreover, the material of the first adhesive material 112 is an irreversible material with the initial state being the liquid state.

Thereafter, a second adhesive material 116 is then coated on the fiber layer 114 in the present embodiment. The second adhesive material 116 is disposed on another substrate 130, so that the fiber layer 114 is sandwiched between the two substrates 110, 130. The two substrates 110, 130 can be made of the same metal or metal alloy, but can also be made of different metals or metal alloys. The second adhesive material 116 and the first adhesive material 112 aforementioned are made of the same material. However, the second adhesive material 116 and the first adhesive material 112 can also be made of different materials such as acrylic gel, PU, epoxy resin, or silicone. In another embodiment, other than adhering the adhesive materials, other fabricating method of attaining this cover plate structure includes, for example, soaking a fiber layer 114 into an adhesive material, disposing the fiber layer 114 on a substrate 110, and then adhering another substrate 130 on the fiber layer 114 having the adhesive material.

In practical application, the two substrates 110, 130 are respectively an outer plate and an inner plate. The outer plate is adopted as a part of the housing of the product. Moreover, the shape of the outer plate can be changed according to the configuration of the product. The inner plate is covered by the outer plate and disposed on an inner wall of the product, and details are described hereinafter.

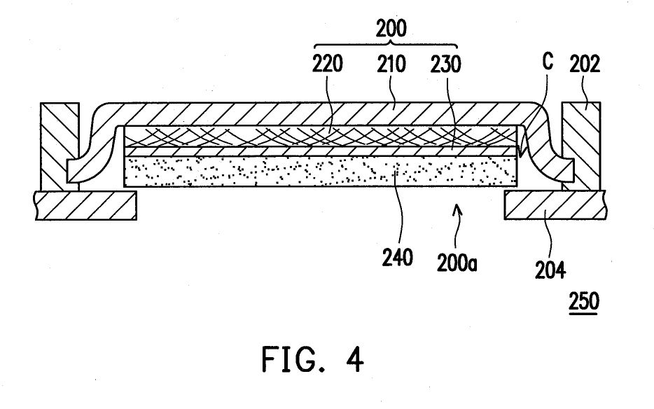

Referring to FIG. 4, FIG. 4 is a schematic view of applying a cover plate in a liquid crystal display (LCD) module. In portable electronic devices, a cover plate 200 is first fixed on a side plate 202, and a LCD module 240 is fixed in a housing assembled by the side plate 202 and the cover plate 200. Finally, a trimming plate 204 is assembled on the aforementioned housing to complete the installation of the LCD module 240. Herein, an outer plate 210 has an accommodating slot C protruding outside of the trimming plate 204, for instance. An inner plate 230 is disposed on an inner wall of the accommodating slot C. Similar to the composite structures shown in FIG. 1 and FIG. 2, a composite structure 220 can be disposed between the outer plate 210 and the inner plate 230 so as to form a cover plate. Consequently, the thickness and weight of the outer plate 210 and the inner plate 230 can be reduced while satisfying the demand in strength endurance. The LCD module 240 is disposed in the accommodating slot C. The LCD module 240 and the inner plate 230 are connected to each other, such that the LCD module 240 is cooled and the location thereof is fixed. In addition, the housing 204 further has an opening 200a exposing the LCD module 240 as a display screen of a portable electronic device 250.

In light of the foregoing, the cover plate of the invention has low specific weight and high strength. Moreover, compared with a metal cover plate having the same thickness, the weight of the cover plate of the invention is reduced. As a consequence, the requirements in product design can then be achieved. Furthermore, the plant fiber has low cost, light weight, and is processed easily, thereby fulfilling the concept of green environmental protection.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A cover plate, comprising:
two substrates; and
a composite structure, disposed between the two substrates and comprising an adhesive layer and a fiber layer, wherein the fiber layer is disposed in the adhesive layer and made of a degradable fiber or a composite material having the degradable fiber fixed by a forming material.

2. The cover plate as claimed in claim 1, wherein the degradable fiber comprises a biodegradable fiber, a chemical degradable fiber, or a photodegradable fiber.

3. The cover plate as claimed in claim 2, wherein the biodegradable fiber comprises a plant fiber.

4. The cover plate as claimed in claim 3, wherein the plant fiber comprises a bamboo fiber, a cane fiber, a flax fiber, a coconut fiber, or a mixture thereof.

5. The cover plate as claimed in claim 3, wherein the plant fiber comprises a straw fiber, a corn husk fiber, or a mixture thereof.

6. The cover plate as claimed in claim 1, wherein the forming material comprises a Mylar film or an artificial glass fiber sheet.

7. The cover plate as claimed in claim 1, wherein the fiber layer is an unevenly aligned mesh structure.

8. The cover plate as claimed in claim 1, wherein the fiber layer is a non-mesh structure.

9. The cover plate as claimed in claim 1, wherein the two substrates are made of metal or metal alloy.

10. The cover plate as claimed in claim 9, wherein a material of the two substrates comprises tinplate, aluminum alloy, magnesium alloy, stainless steel, or titanium alloy.

11. The cover plate as claimed in claim 1, wherein the two substrates respectively serve as an outer plate and an inner plate, and the outer plate covers the inner plate.

12. The cover plate as claimed in claim 11, wherein the outer plate comprises an accommodating slot and the inner plate is disposed on an inner wall of the accommodating slot.

13. The cover plate as claimed in claim 12, wherein a liquid crystal display module is placed in the accommodating slot, and the liquid crystal display module and the inner plate are connected to each other.

14. The cover plate as claimed in claim 11, wherein a material of the outer plate comprises tinplate, aluminum alloy, magnesium alloy, stainless steel, or titanium alloy.

15. The cover plate as claimed in claim 11, wherein a material of the inner plate comprises tinplate, aluminum alloy, magnesium alloy, stainless steel, or titanium alloy.

16. The cover plate as claimed in claim 1, wherein the adhesive layer comprises a first adhesive material and a second adhesive material, and the fiber layer is sandwiched between the first adhesive material and the second adhesive material.

17. The cover plate as claimed in claim 16, wherein the first adhesive material and the second adhesive material are a same material.

18. The cover plate as claimed in claim 16, wherein the first adhesive material and the second adhesive material are different materials.

19. The cover plate as claimed in claim 16, wherein a material of the first adhesive material comprises acrylic gel, polyurethane, epoxy resin, or silicone.

20. The cover plate as claimed in claim 16, wherein a material of the second adhesive material comprises acrylic gel, polyurethane, epoxy resin, or silicone.
